(19) United States
(12) Patent Application Publication
(10) Pub. No.: US 2007/0281550 A1
(43) Pub. Date: Dec. 6, 2007

(54) AUDIO JACK WITH RECHARGING FUNCTION

(75) Inventors: Min-Lung Chien, Taipei (TW); Kai-Ray Cheng, Taipei (TW); Hong-Wei Zheng, Taipei (TW); Guo-Gang Miao, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ADVANCED CONNECTEK INC., Taipei (TW)

(21) Appl. No.: 11/696,188

(22) Filed: Apr. 4, 2007

(30) Foreign Application Priority Data
Jun. 2, 2006 (TW) 95209607

(51) Int. Cl. H01R 24/00

(52) U.S. Cl. 439/660

(57) ABSTRACT

An audio jack for a mobile communications device electrically connected with a first female connector of a charger and a second female connector of a headset thereby is provided. The audio jack includes an insulative housing, a recharging/signal transmitting unit, a first conductive terminal, and an audio terminal, wherein the recharging/signal transmitting unit includes a second conductive terminal and a central terminal. The insulative housing for accommodating all the terminals is formed with a first opening and a second opening communicated therewith for the central terminal. The recharging/signal transmitting unit and the first conductive terminal form means for recharging the charger when the first female connector of the charger is inserted into the first opening; while the recharging/transmitting unit and the audio terminal form means for transmitting audio signals for the headset when the second female connector of the headset is inserted into the first opening.

### CROSS-REFERENCE TO RELATED APPLICATION

This application claims the priority benefit of Taiwan application serial no. 95209607, filed Jun. 2, 2006. All disclosure of the Taiwan application is incorporated herein by reference.

### BACKGROUND OF THE INVENTION

1. Field of the Invention

The present invention relates to an audio jack used for a mobile communications device having a music broadcasting function, and more particularly to an audio jack adapted to recharge a mobile communications device and transmit audio signals from that device.

2. Description of Related Art

The rapid progress in technologies accelerates the research and development of multimedia communication equipment and displays. Not only are their bodies miniaturized, but the number of functions is increased as a result of the development of innovative communication technologies as well. In the earlier days, the communication equipment purely provides a communication function. Nowadays, the communication equipment not only provides voice communication, but also provides other functions including photo taking, music playing, video playing and so on. However, the component of current communication equipment does not provide multiple functions and is a barrier to the miniaturization of the entire equipment body. Moreover, with multiple functions, the multimedia communication equipment has to be frequently charged so that its related products must have a high degree of plugging and unplugging reliability so as to adapt to a frequent connection with an audio jack.

Unfortunately, most conventional audio jacks fail to function normally because an undesired clearance between a central terminal and an insulative housing thereof exists, and the central terminal is unable to be in a perfect contact with a plug of a charger and/or a plug of a headset, causing the device to lose signals. Under the circumstances, there is a need to solve the problem to satisfy the demanding needs of the customers.

### SUMMARY OF THE INVENTION

Accordingly, the present invention is directed to an audio jack that provides multimedia communication equipment or display with a charging function or an audio transmission function through a combination of different terminals.

The present invention is also directed to an audio jack capable of preventing signal loss due to a rotation of a terminal.

Additionally, the present invention is also directed to an audio jack capable of increasing the contact area between terminals so that the connection between terminals is tighter.

To achieve these and other advantages, as embodied and broadly described herein, the invention provides an audio jack for a mobile communications device electrically connected with a first female connector of a charger and a second female connector of a headset thereby. The audio jack includes an insulative housing, a recharging/signal transmitting unit, a first conductive terminal, and an audio terminal, wherein the recharging/signal transmitting unit includes a second conductive terminal and a central terminal. The insulative housing for accommodating all the terminals is formed with a first opening and a second opening communicated therewith for the central terminal. The recharging/signal transmitting unit and the first conductive terminal form means for recharging the charger when the first female connector of the charger is inserted into the first opening; while the recharging/transmitting unit and the audio terminal form means for transmitting audio signals for the headset when the second female connector of the headset is inserted into the first opening.

In addition, the ends of the central terminal are a first contact portion and a second contact portion respectively. The central terminal has a latching portion and a joining portion disposed between the first contact portion and the second contact portion. Furthermore, the joining portion has a width smaller than the latching portion. The surface of the latching portion is engraved with a protruding pattern such that the protruding pattern may form a tight interferential fitting with the insulative housing when the central terminal is assembled inside the insulative housing. This prevents the terminal from producing any rotation.

Furthermore, the joining portion of the central terminal has a width slightly greater than the groove of the second conductive terminal. Therefore, the groove will pierce into the joining portion to form an interferential fitting when the two are assembled. This arrangement not only prevents the central terminal from detaching from the insulative housing, but also increases the contact area between the terminals so that the stability of the electrical connection is enhanced.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of an audio jack according to one preferred embodiment of the present invention;

FIG. 2 is an exploded view showing the audio jack shown in FIG. 1;

FIGS. 3A is a cross-sectional view taken along line A-A shown in FIG. 1;

FIG. 3B is a partially enlarged view of FIG. 3A; and

FIG. 4 is a cross-sectional view taken along line B-B shown in FIG. 1.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

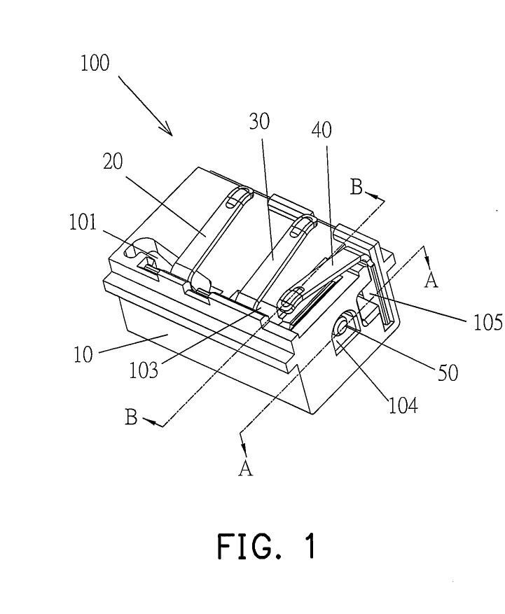

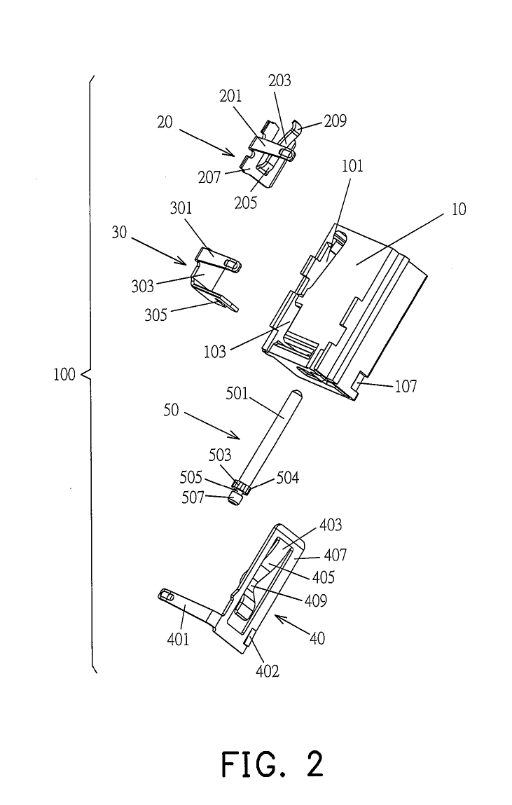

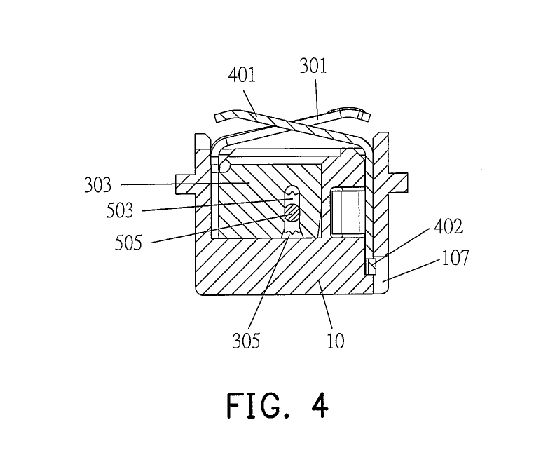

Referring to FIG. 1, an audio jack 100 provide electrical paths for recharging and transmitting audio signals is disclosed. The audio jack includes an insulative housing 10, and a first conductive terminal 20, a second conductive terminal 30, an audio terminal 40 and a central terminal 50 inserted therein. In the following, refer to FIGS. 2, 3A, 3B and 4 for a detailed description of various components of the audio jack 100.

As seen along the line B-B, the insulative housing 10 has a front face 10a, a rear face 10b, a left face 10c, a right face 10d, a top face 10e and a bottom face 10f. The insulative housing 10 is provided with a first opening 102 on the front face 10 thereof, and a second opening 104 on the rear face 10b thereof. The two openings 102, 104 are communicated with each other for accommodating the central terminal 50. A third insertion slot 105 for receiving the audio terminal 40 is provided on the front face 104 of the insulative housing 10. Furthermore, the bottom surface of the insulative housing 10 has a first insertion slot 101 and a second insertion slot 103 for inserting the first conductive terminal 20 and the second conductive terminal 30, which are formed an integrated body with the insulative housing 10.

The first conductive terminal 20 is substantially a single piece element made of metal, which includes a U-shaped portion 207, a first elastic arm 201 perpendicularly connected to and extending from the U-shaped portion 207, a first base portion 205 connected to and extending from the U-shaped portion 207, a first elastic contact arm 203 extending from the first base portion 205, and a first elastic contact portion 209 extending from first elastic contact arm 203. In detail, the first elastic arm 201 is extending upward from the first U-shaped portion 207. The first elastic contact arm 203 is formed by making horizontal cutting on three sides. The first elastic contact arm 203 and the body of the first U-shaped portion 207 are connected with the first base portion 205, and the first elastic contact arm 203 extends from the first base portion 205 in the cutting direction. The first elastic contact arm 203 is connected to the first elastic contact portion 209.

The aforementioned second conductive terminal 30 includes a L-shaped latching plate 303 and a second elastic arm 301 extending upward from a top end of a L-shaped surface of the latching plate 303. Furthermore, the bottom end at another surface of the L-shaped latching plate 303 has a concave upward groove 350.

The ends of the aforementioned central terminal 50 includes a first contact portion 501 and a second contact portion 507 respectively, and the central terminal 50 further has a latching portion 503 and a joining portion 505 disposed between the first contact portion 501 and the second contact portion 507. Furthermore, the joining portion 505 has a width smaller than the latching portion 503. The surface of the latching portion 503 is engraved with a protruding pattern 504 such that the protruding pattern 504 may form a tight interferential fitting with the insulative housing 10 when the central terminal 50 is assembled inside the insulative housing 10. This prevents the central terminal 50 from rotating with respect to the insulative housing.

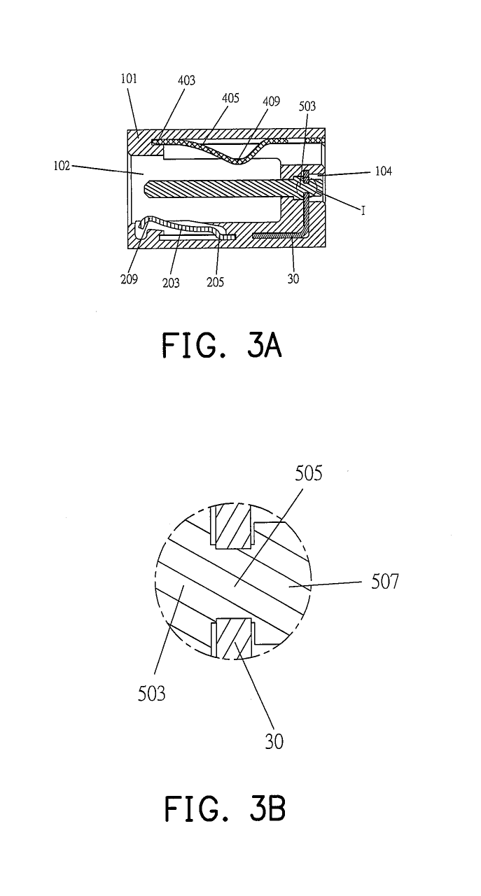

As shown in FIG. 3B, the joining portion 505 may have a width greater than or equal to the groove 305. When the joining portion 505 is assembled to the groove 305 on the second conductive terminal 30, the central terminal 50 is prevented from detaching from the insulative housing 10 only if the joining portion 505 has a width equal to the groove 305. When the joining portion 505 has a width greater than the groove 305, the groove 305 will pierce into the joining portion 505 and form an interferential fitting when they are assembled. This arrangement not only prevents the central terminal 50 from detaching from the insulative housing 10, but also increases the contact area between the terminals so that the stability of the electrical connection is enhanced.

The aforementioned audio terminal 40 is substantially a single piece element made of metal, which includes a third elastic arm 401, a second base portion 403, a second elastic contact arm 405, a O-shaped portion 407, and a second elastic contact portion 409. In detail, the third elastic arm 401 is perpendicularly connected to a top end of the O-shaped portion 407. The second elastic contact arm 405 is formed by making horizontal cutting on three sides. The second elastic contact arm 405 and the body of the O-shaped portion 407 are connected with the second base portion 403 and the second elastic contact arm 405 extends from the second base portion 403 in the cutting direction. The second elastic contact arm 405 is connected to the second elastic contact portion 409. In addition, the audio terminal 40 has a protruding plate 402 underneath the O-shaped portion 407 such that the protruding plate 402 may latch onto the latching hole 107 on the insulative housing 10 when the audio terminal 40 is inserted into the insulative housing 10. Hence, the audio terminal 40 is prevented from detaching from the insulative housing 10.

According to the present invention, the second conductive terminal 30 and the central terminal 50 serves as a recharging/signal transmitting unit.

When a user of the mobile communications device having the above audio jack 100 insert a first female connector of his/her charger into the audio jack, the second conductive terminal 30, central terminal 50 and the first conductive terminal 20 of the audio jack 100 form an electrical path allowing the charger to recharge the mobile communications device.

When a second female connector of his/her headset is inserted into the audio jack, the second conductive terminal 30, the central terminal 50 and the audio terminal 40 of the audio jack 100 form another electrical path allowing the mobile communications device to transmit the audio signals to the headset.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An audio jack for a mobile communications device electrically connected with a first female connector of a charger and a second female connector of a headset thereby, the audio jack comprising:
a first conductive terminal;
a recharging/signal transmitting unit, including a second conductive terminal and a central terminal;
an audio terminal; and
an insulative housing for accommodating all the terminals, the insulative housing formed with a first opening and a second opening communicated therewith for the central terminal;
wherein the recharging/signal transmitting unit and the first conductive terminal form means for recharging the charger when the first female connector of the charger is inserted into the first opening; while the recharging/transmitting unit and the audio terminal form means for transmitting audio signals for the headset when the second female connector of the headset is inserted into the first opening.

2. The audio jack of claim 1, wherein the first conductive terminal comprises:
a U-shaped portion;
a first elastic arm extending upward from a top end of the first U-shaped portion,
a first base portion;
a first elastic contact arm formed by making horizontal cutting on three sides, wherein the first elastic contact arm is connected to the body of the first U-shaped portion through the first base portion; and
an elastic contact portion extending in the cutting direction of the first base portion.

3. The audio jack of claim 1, wherein the second conductive terminal comprises an L-shaped latching plate and a second elastic arm extending upward at a top end of an L-shaped surface of the latching plate, and the bottom end at another surface of the L-shaped latching plate has a concave upward groove.

4. The audio jack of claim 1, wherein two ends of the central terminal are a first contact portion and a second contact portion, and the central terminal has a latching portion and a joining portion disposed between the ends such that the joining portion has a width smaller than the latching portion.

5. The audio jack of claim 4, wherein the surface of the latching portion is engraved with a protruding pattern such that the protruding pattern forms a tight interferential fitting with the insulative housing and prevents the central terminal from producing any rotation.

6. The audio jack of claim 4, wherein the joining portion of the central terminal forms an interference with the groove in the second conductive terminal such that the central terminal is prevented from detaching from the insulative housing.

7. The audio jack of claim 6, wherein the groove in the second conductive terminal has a width slightly smaller than the joining portion of the central terminal so that the groove pierces into the joining portion and forms an interferential fitting.

8. The audio jack of claim 1, wherein the audio terminal comprises:
an O-shaped portion;
a third elastic arm extending upward from a top end of the O-shaped portion,
a second base portion;
a second elastic contact arm formed by making horizontal cutting on three sides, wherein the second elastic contact arm is connected to the O-shaped portion through the second base portion; and
a second elastic contact portion extending from the second base portion in the cutting direction.

9. The audio jack of claim 8, wherein the audio terminal has a protruding plate underneath the O-shaped portion for latching onto a latching hole on the insulative housing when the audio terminal is inserted into the insulative housing and preventing the audio terminal from detaching from the insulative housing.
